(19) United States
(12) Patent Application Publication
(10) Pub. No.: US 2002/0167160 A1
(43) Pub. Date: Nov. 14, 2002

(54) Method for obtaining business referrals using before and after images

(76) Inventor: Laurence L. Lamson, Wichita, KS (US)

Correspondence Address: HOVEY, WILLIAMS, TIMMONS & COLLINS, Suite 400, 2405 Grand, Kansas City, MO, 64108, US

(21) Appl. No.: 09/854,868

(22) Filed: May 14, 2001

(51) Int. Cl. B42D 15/00

(52) U.S. Cl. 283/70

(57) ABSTRACT

A method for creating and using a business referral card that includes personalized before and after images of an object that has been improved by the goods or services rendered by a vendor. Included on the business referral card is a vendor identifier which will allow potential customers to contact the vendor and customer identification information that allows the vendor to reward a present customer for successfully referring new business to the vendor.

### FIELD OF THE INVENTION

The present invention relates to a method for increasing business referrals. More particularly, the invention relates to advertising business services and products utilizing before and after images of work performed and providing incentives to former customers to pass out business cards containing those images.

### BACKGROUND

At present, typical means of advertising utilized by professionals and small businesses include advertising in the yellow pages, advertising in newspapers and other periodicals, and advertising with local broadcast media outlets. Advertising through these media outlets can be relatively expensive for small businesses and professionals and the efficacy of such advertising is difficult to ascertain. On the other hand, word-of-mouth advertising is typically free, and in the experience of many small businesses and professionals highly effective. Personal recommendations among friends and acquaintances are more effective than advertisements in printed publications. Thus, if small businesses or professionals could find some way to effectively enhance word-of-mouth advertising by supplying customers with compelling advertising information and giving them incentives to recommend their goods or services while giving that information to friends and acquaintances, the high cost of print and broadcast media advertising may be avoided while at the same time increasing the effectiveness of the advertising.

It is desirable then to develop a new method of enhancing word-of-mouth advertising that will encourage customers to relate their good experiences in dealing with the goods or services of a business and at the same time provide those customers with compelling advertising information that is easy to carry and disseminate to potential customers.

### SUMMARY OF THE INVENTION

The present invention solves the above-described problems and provides a distinct advance in the art of business referral advertising. More particularly, the present invention provides a business referral card format that includes personalized before and after images of an object that has been improved by the goods or services rendered by a vendor. Included on the business referral card is a vendor identifier which will allow potential customers to contact the vendor and customer identification information that allows the vendor to reward a present customer for successfully referring new business to the vendor.

In a separate aspect of the present invention a method of creating referral business cards is disclosed in which personalized before and after images of an object that has been improved by the goods or services rendered by the vendor are captured, imported in a digital format, placed and sized to fit within a layout of the business referral card, and a customer identifier is imported and placed within the layout of the business referral card. Included on the business referral card is a vendor identifier which will allow potential customers to contact the vendor.

In a separate aspect of the present invention a method of obtaining referral business is disclosed in which a vendor creates a referral business card containing personalized before and after images of an object that has been improved by the goods or services rendered by the vendor. Included on the business referral card is a vendor identifier which will allow potential customers to contact the vendor and customer identification information that allows the vendor to reward a present customer for successfully referring new business to the vendor.

By constructing a business referral card as described herein, numerous advantages are realized. For example, compelling information regarding the ability of the vendor to improve an object is given to customers to enhance their ability to provide word-of-mouth referrals in conjunction with an incentive program which encourages the customers to make such referrals. In this way, relatively inexpensive and highly effective advertising becomes available for use by businesses and professionals.

These and other important aspects of the present invention are described more fully in the detailed description below.

### BRIEF DESCRIPTION OF THE DRAWINGS

A preferred embodiment of the present invention is described in detail below with reference to the attached drawing figures, wherein:

FIG. 1 is a schematic drawing of a preferred embodiment of a business referral card of the present invention; and

FIG. 2 is a flow diagram of a preferred embodiment of the steps to create a business referral card of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

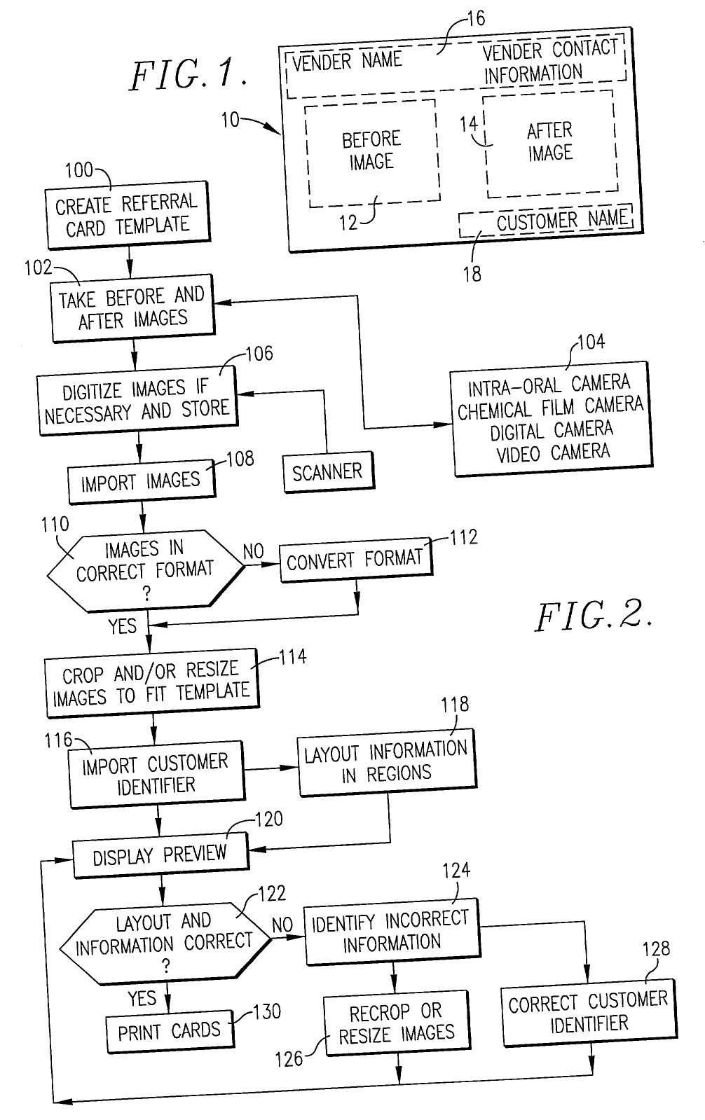

Turning now to the drawing figures, and particularly to FIG. 1, a business referral card 10 arranged in accordance with a preferred embodiment of the invention is illustrated. The business referral card broadly includes four separate regions containing different information for use in the method of the present invention. One region 12 contains a before image of an object upon which a vendor will improve through the supply of goods or services. One region 14 contains an after image showing the object after the vendor has supplied goods or services to improve the object. One region 16 contains vendor information to identify the supplier of goods or services that affected the improvement to the object. And finally, one region 18 contains customer identification information. The term object is used here to generically describe many different things upon which goods or services may be rendered to improve them. For example, before and after images may be used for orthodontics, cosmetic dentistry, plastic surgery, weight loss, home improvement, landscaping, and many others.

The before and after image regions 12, 14 may contain images in either portrait or landscape mode. In one version of the business card, the card itself measures 8½″×4½″ with the before and after images 12, 14 measuring 2″×2⅞″ in landscape mode or 2¼×2½″ in portrait mode. The purpose of this relatively large business card is for a static display such as on a refrigerator, bulletin board, or other location where it is likely to be seen if left on display. The business cards may also measure 3½″×2″. In this embodiment, the before and after images 12, 14 can measure 1 1/16″×1 5/16″ in landscape mode and 1″×1¼″ in portrait mode. It has been found that by employing these card size and image size dimensions, one large card and six small cards can be printed out on a single 8½″×11″ sheet of card stock. Preferably the card stock comes with perforations along these dimensions to improve the ability of a customer to separate the cards. Many other card sizes and image dimensions are of course possible without departing from the scope of the invention.

Generally speaking, it is expected that multiple copies of the same card will be made. The purpose of the card is to place in the hands of a customer easily accessible and compelling evidence of the efficacy of the value of the goods or services rendered by the vendor. Thus, the before and after images on the card will provide visual evidence of the work performed by the vendor. Although it would be possible to provide before and after images of any work previously done, it is contemplated that this type of personalized advertising will be most effective when the before and after images are of work performed for the specific customer for whom the cards are being made. In the ordinary course of the customer's interaction with others, the customer can hand out copies of the card when recommending the vendor's goods or services. As stated above, the card will show all identifying information necessary for a potential customer who receives the card to contact the vendor.

Although there are many customers who would hand out such information without any particular incentive from the vendor, it is useful to provide an incentive to the customer in order to increase the number of cards handed out by a customer and consequently increase the potential for new business. The particular incentive to be used by a vendor can be nearly anything that would induce customers to participate in the program. Typical examples include goods or services of the kind already produced by the vendor, gifts or gift certificates from vendors of other related goods or services, and a large prize awarded on a yearly basis for the customer making the most referrals. These examples are merely illustrative of the many types of incentives that may be provided and are not intended to be limiting.

Because it is contemplated that before and after images personalized for each customer will be most effective in advertising the vendors goods or services, it is desirable to automate the process of creating personalized referral cards. FIG. 2 is a flow diagram showing the process for creating personalized referral cards. While it is preferable to perform these steps using software running on a personal computer, these steps can also be carried out entirely manually, in part manually combined with computer software steps, or entirely through software utilizing other types of computing equipment without departing from the scope of the invention. The process begins at step 100 where a template defining the size of the business referral card and the size and placement of the regions on the business referral card is determined. This step can be performed once for all business referral cards, or alternatively, multiple templates may be used and selected between by the vendor or customer. Commercially available business card software called Business Cards™ 1998 from Learning Company Properties may also be used to accomplish this step. Because the vendor information will not change from customer to customer, a particular vendor using the process of the invention can place the vendor identifier in its region at this step.

At step 102 before and after images of the object for which goods and services are provided are taken. Depending on the object specifically being improved, many different instrumentalities may be used to obtain the image. For instance, in the case of the work of a cosmetic dentist or orthodontist, an intraoral or extra-oral camera would be used to take images of the patient's teeth both before and after services have been rendered by the professional. Likewise, in the case of home improvement a camera using photographic film, a digital camera, or a video camera from which image stills can be captured may all be used as appropriate. A variety of possible instruments for obtaining the image are listed in block 104, however this list is not exclusive. At step 106 images that were not originally obtained in a digital format must be digitized. Many acceptable commercially available color scanners to carry out this step are available from vendors such as Hewlett Packard. Once the images have been digitized they can be stored under the customer/patient name for future use. The stored images are then imported for use by the computer program at step 108.

At step 110, it must be determined whether the imported images are in the correct digital format to be used by the program. If the images are not in the correct format, step 112 is performed which converts between digital formats so that the right format will be used. Preferred digital formats in this case include JPEG or GIF. After step 112, or if the images were already in the correct digital format, step 114 is performed. At step 114 the images are manipulated by cropping and/or resizing to fit within the before and after regions on the referral card. Typically, there are several different resolutions measured by pixel density and expressed as the number of horizontal and vertical pixels within the image that the images may have. It has been found that images with a resolution of 200×150 pixels are sufficiently clear to convey attractive and informative images for use on the referral card. The pixel resolution can also be altered at this step to improve clarity. Commercially available software such as Adobe® Photoshop® can also be used to accomplish this step.

At step 116 customer information is imported. This information can include the customer's name or may simply be a number that identifies the customer to the vendor. This step may be accomplished either by manual entry of the customer identifier or importation of the customer identifier from an already existing database. Having imported all of the necessary information, the different regions are then filled in with the appropriate information at step 118. At step 120 a preview screen displays an example of what the referral card will look like if the current layout is accepted. Alternatively, if a combination manual and software approach using commercially available software is being used, a single card or sheet of cards can be printed to check on the acceptability of the card layout at this step.

Step 122 determines if the card layout and information contained therein is correct. If the card layout or information is not correct, step 124 determines whether it is the layout or information contained within the layout that is incorrect. Depending on what information is wrong, the next step will either be step 126 or step 128. At step 126 the images can be resized to fit their respective regions. Resizing can include either increasing or decreasing the image size in either dimension or cropping the image. Next, the process returns to step 120 where a preview of the referral card is displayed. If the customer identifier was incorrect at step 124, step 128 is performed where the customer information is corrected. After step 128, step 120 is performed to display a preview of the referral card with the corrected information. If the layout and information is correct, step 130 is performed next and the referral cards are printed. There are many commercially available printers suitable for performing this step, although color images are preferable and hence a color printer is preferably used for this step. Hewlett Packard makes several models that are satisfactory for the purposes of the invention. Once the cards are printed the process is complete and the cards may be given to the particular customer for whom they were created.

Other enhancements are possible to streamline the process described above. For example, in the case of a medical professional's office where several patients may be located in different rooms, the tools necessary for creating the referral cards can be kept on a cart. Such a cart would contain a computer running the above described computer program and a digital camera for capturing before and after images. The cart may be easily moved from room to room so that before and after images may be captured and stored in the computer and the program executed to create the layout for the referral card. Once the card has been laid out, the computer may be connected to a color printer on the cart or elsewhere within the office and the cards printed can be.

The above description of the invention is intended to be illustrative and not limiting. Other embodiments of this invention will be obvious to those skilled in the art in view of the above disclosure.

1. A method of making business referral cards comprising: obtaining a first image of an object to be improved; obtaining a second image of the object after improvement; converting the first and second images to a digital format; manipulating the first and second images to fit on a business card containing a vendor identifier for identifying the vendor of object improvement;
placing the manipulated first and second images on the business card; and
placing a customer identifier on the business card.

2. The method of claim 1 wherein the step of converting consists of scanning the first and second images with a digital scanner.

3. The method of claim 1 wherein the step of obtaining comprises taking pictures with an intra-oral camera.

4. The method of claim 1 wherein the step of obtaining comprises taking pictures with a digital camera.

5. The method of claim 1 wherein the step of obtaining comprises taking pictures with a video camera.

6. The method of claim 1 wherein the step of obtaining comprises taking pictures with a film based camera.

7. A method of obtaining business referrals comprising:
obtaining a first image of a customer object before improvement thereof by a vendor;
obtaining a second image of a customer object after improvement thereof by the vendor;
placing the first and second images on a business card containing a vendor identifier;
placing a customer identifier on the business card; and
providing a reward to the customer for successfully referring business to the vendor.

8. The method of claim 7, the reward being provided when a new customer purchases goods or services from the vendor and returns the card to the vendor.

9. A business referral card comprising:
a first region containing a first image of an object before the object has been improved;
a second region containing a second image of the object after the object has been improved;
a third region containing a customer identifier for identifying the object owner; and
a fourth region containing a vendor identifier for identifying the vendor of object improvement.
